(19) United States
(12) Patent Application Publication
(10) Pub. No.: US 2004/0204144 A1
(43) Pub. Date: Oct. 14, 2004

(54) Device and method for transmitting display data in a mobile communication terminal with camera

(76) Inventor: Chae-Whan Lim, Taegukwangyok-shi (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/419,863

(22) Filed: Apr. 22, 2003

(30) Foreign Application Priority Data
Apr. 22, 2002 (KR) 2002-22066

(51) Int. Cl. H04B 1/38

(52) U.S. Cl. 455/566; 455/550.1; 455/575.1

(57) ABSTRACT

A camera captures an object's image and generates image data. An image processor processes the image data generated by the camera on the basis of a predetermined display standard. A user data generator generates user data according to a display mode. A display unit displays the image data on a first display area and displays the user data on a second display area. A controller controls transmission paths such that the image data from the image processor is transmitted to the first display area of the display unit in a first display time for a frame, and the user data is transmitted to the second display area in a second display time, at each frame when an operating mode is an image capture mode.

### PRIORITY

This application claims priority under 35 U.S.C. § 119 to an application entitled “DEVICE AND METHOD FOR TRANSMITTING DISPLAY DATA IN MOBILE COMMUNICATION TERMINAL WITH CAMERA”, filed in the Korean Industrial Property Office on Apr. 22, 2002 and assigned Serial No. 2002-22066, the contents of which are hereby incorporated by reference.

### BACKGROUND OF THE INVENTION

1. Field of the Invention

The present invention relates to a device and method for transmitting data in a mobile communication terminal, and more particularly to a device and method for transmitting a moving picture of image data captured by a camera and user data to a display unit.

2. Description of the Related Art

Mobile communication terminals have recently developed into structures capable of transmitting high-speed data while retaining their voice communication function. A mobile communication network based on an international mobile telecommunication-2000 (IMT-2000) standard can implement high-speed data communication as well as voice communication using the mobile communication terminal. Data capable of being processed in the mobile communication terminal for performing the data communication can be packet data and image data.

Conventionally, an image processing device includes a camera for capturing an image and a display unit for displaying the image captured by the camera. The camera can use a charge coupled device (CCD) image sensor or a complementary metal oxide semiconductor (CMOS) image sensor. As camera devices become smaller, the image capturing devices must also be miniaturized. A trend has developed wherein mobile communication terminals are equipped with camera devices. Mobile communication terminals can capture images, and display moving and still pictures. Subsequent to capturing an image, the mobile communication terminal can transmit the captured images to a base station.

A mobile communication terminal with a camera must be able to indicate a change of reception sensitivity of a radio frequency (RF) signal from the base station and the remaining amount of a battery power, and simultaneously display user data such as icons, characters, etc. for a user interface and moving picture data captured by the camera. When image data captured by the camera provided in the mobile communication terminal, and user data for the user interface to be displayed, are transmitted to a display unit, control operations must be able to be appropriately performed. For example, display paths of the image data captured by the camera and the user data for the user interface must be able to be independently controlled.

### SUMMARY OF THE INVENTION

Therefore, it is an object of the present invention to provide a device and method capable of displaying image data captured by a mobile communication terminal with a camera and user data on predetermined display areas included in one screen of a display unit.

It is another object of the present invention to provide a device and method capable of transmitting, to a display unit, image data captured by a mobile communication terminal with a camera in a predetermined frame time at each frame, and transmitting user data to the display unit in another time.

It is still another object of the present invention to provide a device and method enabling a controller to perform a control operation in a mobile communication terminal with a camera and an image processor such that an output of the image processor can be displayed when capturing frame image data, and user data can be displayed during a frame pause.

It is yet another object of the present invention to provide a device and method capable of capturing a still picture from moving picture data and storing the captured still picture, to allow the moving picture data captured by a mobile communication terminal with a camera and user data to be displayed on one screen.

In accordance with one aspect of the present invention, the above and other objects can be substantially accomplished by a device for displaying an image in a mobile communication terminal, comprising a camera for capturing an object's image and generating image data; an image processor for processing the image data generated by the camera on the basis of a predetermined display standard; a user data generator for generating user data according to a display mode; a display unit for displaying the image data on a first display area and displaying the user data on a second display area; and a controller for controlling transmission paths such that the image data from the image processor is transmitted to the first display area of the display unit in a first display time, and the user data is transmitted to the second display area of the display unit in a second display time, at each frame when an operating mode is an image capture mode.

In accordance with another aspect of the present invention, there is provided a device for displaying an image in a mobile communication terminal, comprising a camera for capturing an object's image and generating image data; an image processor including a display data processor for processing the image data generated by the camera on the basis of a predetermined display standard, and an image codec for compressing and decompressing the image data; a user data generator for generating user data according to a display mode; a display unit for displaying the image data on a first display area and displaying the user data on a second display area; and a controller for cutting off a path of the image data by controlling the display data processor in a still-picture capture mode, compressing the image data displayed on the first display area by driving the image codec, and storing the compressed image data as a still picture in a memory.

In accordance with another aspect of the present invention, there is provided a method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of activating a transmission path of the image data generated by the camera in a first display time for a frame, processing the image data generated by the camera on the basis of a predetermined display standard, and transmitting the processed image data to the first display area of the display unit; and inactivating the transmission path of the image data generated by the camera in a second display time, activating a transmission path of the user data, and transmitting the user data to the second display area of the display unit.

In accordance with yet another aspect of the present invention, there is provided a method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of transmitting the image data generated by the camera and the user data generated by the user data generator to the first and second display areas of the display unit in the image capture mode, and displaying a moving picture; when a still-picture capture command is generated in an image capture mode, inactivating the transmission path of the image data generated by the camera, displaying the image data displayed on the display unit as a still picture, compressing and encoding the image data displayed on the display unit, and registering the compressed and encoded image data as the still picture.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an example of components of a mobile communication terminal in accordance with an embodiment of the present invention;

FIG. 2A is a block diagram illustrating an example of components of an image processor shown in FIG. 1 in accordance with an embodiment of the present invention;

FIG. 2B is a block diagram illustrating another example of components of the image processor shown in FIG. 1 in accordance with an embodiment of the present invention;

FIG. 3 is a timing diagram illustrating an example of transmission timings of data and signals used for the mobile communication terminal shown in FIG. 1 in accordance with an embodiment of the present invention;

FIG. 4 is a flow chart illustrating an example of steps for displaying image data in the mobile communication terminal in accordance with an embodiment of the present invention;

FIG. 5 is a block diagram illustrating another example of components of the mobile communication terminal in accordance with an embodiment of the present invention;

FIG. 6 is a block diagram illustrating an example of components of a signal processor shown in FIG. 5 in accordance with an embodiment of the present invention;

FIG. 7 is a block diagram illustrating an example of components of the image processor shown in FIG. 1 or 5 in accordance with an embodiment of the present invention; and

FIG. 8 is a timing diagram illustrating an example of timing signals for transmitting an image signal captured by a camera from an image processing device shown in FIG. 5 to a display unit in accordance with an embodiment of the present invention; and

FIG. 9 is a diagram illustrating an example of a scaler shown in FIG. 7 in accordance with an embodiment of the present invention.

### DETAILED DESCRIPTION OF THE PREFERRED EMBODIMENTS

Embodiments of the present invention will be described in detail with reference to the accompanying drawings. In the drawings, the same or similar elements are denoted by the same reference numerals.

Those skilled in the art will appreciate that specific criteria such as a transmission rate of an image signal transmitted from a camera, the number of pixels of image signals captured by the camera, the number of pixels of image signals capable of being displayed on a display unit, etc. are described only for illustrative purposes to help in understanding the present invention. It should also be appreciated that the present invention can also be implemented without the specific criteria.

The term “image capture mode” refers to an operating mode for capturing image signals through a camera and displaying moving picture signals on a display unit. The term “path control mode” refers to an operating mode for controlling a path of data transmitted to a display unit. The term “first path control signal” refers to a signal for activating a path for transferring the image signals captured by the camera to the display unit, and the term “second path control signal” refers to a signal for activating a path for enabling the controller to access the display unit. The term “preview” refers to an operation of displaying moving picture signals captured by the camera. The term “still-picture capture” refers to an operation of capturing and storing a still picture in a preview state.

It is assumed that a device for capturing and displaying an image is a mobile communication terminal in accordance with embodiments of the present invention. However, the device and method in accordance with embodiments of the present invention can be applied to any mobile communication device for displaying an image using a camera other than the mobile communication terminal.

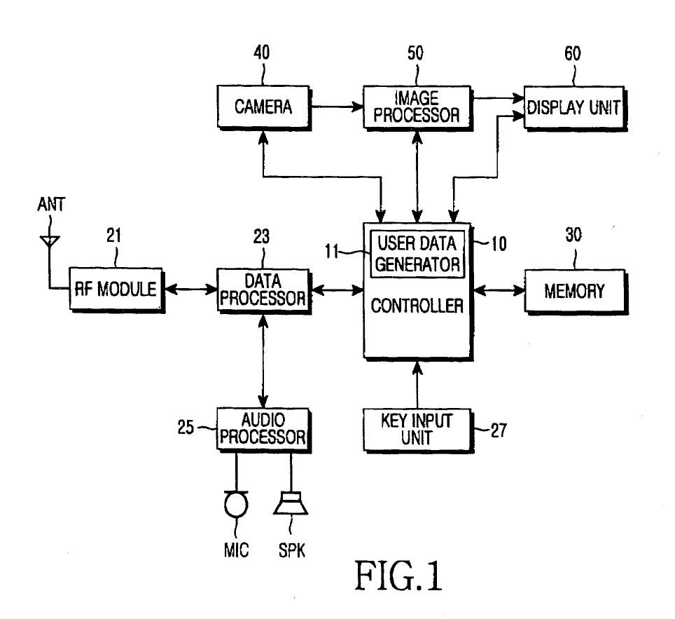

FIG. 1 is a block diagram illustrating an example of components of a mobile communication terminal in accordance with an embodiment of the present invention. The mobile communication terminal is preferably an image processing device in accordance with an embodiment of the present invention.

Referring to FIG. 1, a radio frequency (RF) module 21 performs communication functions for the mobile communication terminal. The RF module 21 includes an RF transmitter (not shown) for up-converting and amplifying a frequency of a signal to be transmitted, an RF receiver (not shown) for performing low noise amplification for a received signal and down-converting a frequency of the amplified received signal, etc. The RF module 21 is connected to an antenna (ANT). A data processor 23 includes a transmitter (not shown) for encoding and modulating the transmission signal, a receiver (not shown) for demodulating and decoding the received signal, etc. The data processor 23 can be configured by a modem and a codec. An audio processor 25 reproduces an audio signal received from the data processor 23 and provides the audio signal to a speaker (SPK) or transmits an audio signal from a microphone (MIC) to the data processor 23.

A key input unit 27 includes keys for inputting numeric and character information and function keys for setting various functions. The key input unit 27 further includes an image capture mode key, a still-picture capture key, etc. in the embodiment of the present invention. A memory 30 comprises a program memory and a data memory. The program memory can store programs for controlling a general operation of the mobile communication terminal and programs for controlling the display of image signals in accordance with an embodiment of the present invention. The data memory performs a function of temporarily storing data generated while the programs are being performed. Moreover, an image memory for storing the captured image signals can be provided in accordance with an embodiment of the present invention.

The controller 10 controls an entire operation of the mobile communication terminal. In an embodiment of the invention, the controller 10 can include the data processor 23. In accordance with an embodiment of the present invention, the controller 10 sets an image capture mode in response to a function key input from the key input unit 27. The controller 10 performs a control operation such that image data captured according to the set image capture mode can be displayed as a moving picture or stored as a still picture. Further, the controller 10 controls paths for transmitting the image data captured by the camera and user data generated from the controller 10 to a display unit 60 in accordance with an the embodiment of the present invention. Furthermore, the controller 10 includes a user data generator 11 for generating the user data for indicating a corresponding mode menu in an image display mode, e.g., the image capture mode.

A camera 40 for capturing an object's image includes a camera sensor (not shown) for converting an optical signal of the captured object image into an electric signal. The camera sensor can be a charge coupled device (CCD) image sensor or a complementary metal oxide semiconductor (CMOS) image sensor. In an embodiment of the present invention, it is assumed that the camera sensor is the CCD image sensor. Further, the camera 40 generates digital image data from the image signals and outputs the generated digital image data. An image processor 50 performs a function of generating screen data for displaying the image data output from the camera 40. The image processor 50 transmits the image data on the basis of a display standard of the display unit 60 controlled by the controller 10.

The display unit 60 displays the image data received from the image processor 50 on a screen, and displays user data received from the controller 10. The display unit 60 can include a first display area for displaying the image data received from the image processor 50 and a second display area for displaying the user data received from the controller 10. In an embodiment of the invention the display unit 60 can be a liquid crystal display (LCD). The display unit 60 can include an LCD controller, a memory for storing image data, LCD elements, etc. When the LCD is implemented in the form of a touch screen, the key input unit 27 will comprise a LCD screen as the input unit.

An operation of the mobile communication terminal will be described with reference to FIG. 1. If a user performs a dialing operation using the key input unit 27 when transmitting a call signal, and sets a call signal transmitting mode, the controller 10 detects the set call signal transmitting mode, processes dialing information received from the data processor 23, converts the dialing information into an RF signal via the RF module 21, and outputs the RF signal. Then, if a called party generates a response signal, the controller 10 detects the response signal from the called party via the RF module 21 and the data processor 23. A voice communication path is then established via the audio processor 25, such that the user can communicate with the called party. In a call signal receiving mode, the controller 10 detects the call signal receiving mode through the data processor 23, and generates a ring signal through the audio processor 25. Then, if the user gives a response to the ring signal, the controller 10 detects the response to the ring signal. Thus, the voice communication path is established via the audio processor 25, such that the user can communicate with a calling party. The voice communication in the call signal transmitting and receiving modes have been described as an example. The mobile communication terminal can perform a data communication function for packet data and image data communications as well as perform the voice communication function. Moreover, when the mobile communication terminal is in a standby mode or performs character communication, the controller 10 controls the display unit 60 such that the display unit 60 displays character data processed by the data processor 23.

The mobile communication terminal captures an image of a person or peripheral environment, and displays or transmits the image. The camera 40 is mounted in the mobile communication terminal or connected to the mobile communication terminal at a predetermined external position. That is, the camera 40 can be an internal or external camera. The camera 40 can use a charge coupled device (CCD) image sensor or a complementary metal oxide semiconductor (CMOS) image sensor. Further, the camera 40 can include a signal processor for converting an image signal into digital image data. The signal processor can be embedded in the camera 40 or the image processor 50. In an embodiment of the invention, the signal processor can be independently configured. It is assumed that the signal processor is embedded in the camera 40. After an image captured by the camera 40 is converted into an electric signal by the internal CCD image sensor, the signal processor converts the image signal into digital image data and then outputs the digital image data to the image processor 50.

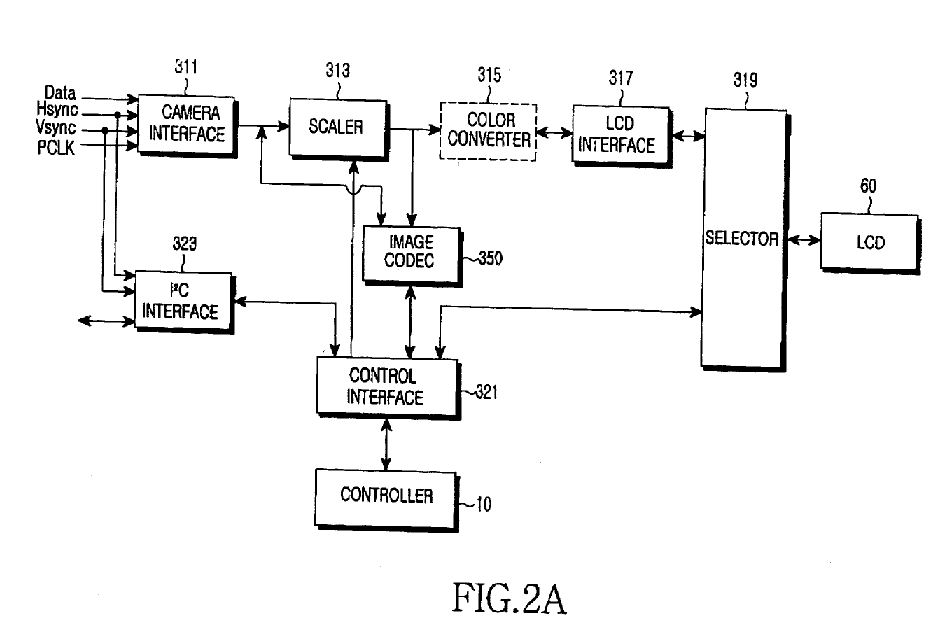

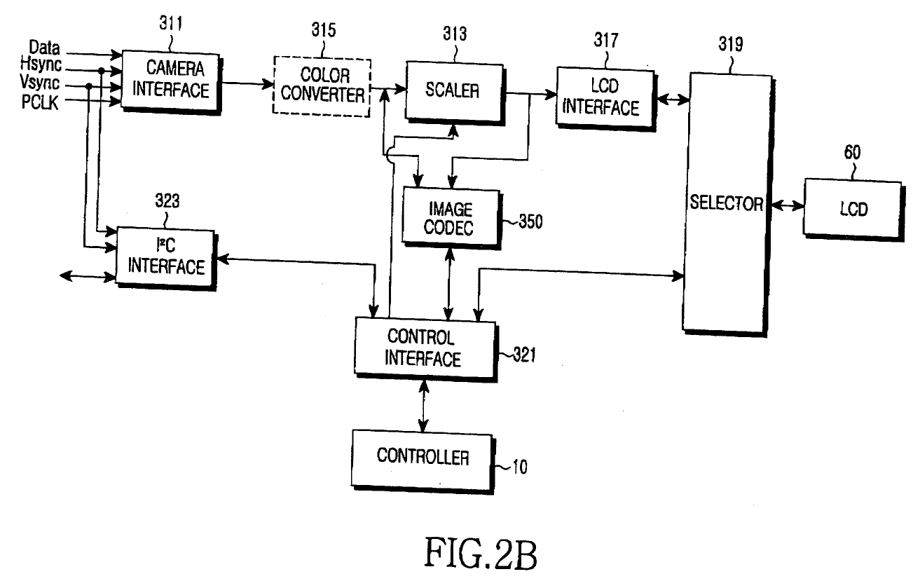

FIG. 2A is a block diagram illustrating an example of components of an image processor shown in FIG. 1 in accordance with an embodiment of the present invention. FIG. 2B is a block diagram illustrating another example of components of the image processor shown in FIG. 1 in accordance with an embodiment of the present invention. FIGS. 2A and 2B illustrate a configuration of the image processor 50. The image processor 50 performs an interface function for image data between the camera 40 and the display unit 60. That is, the image processor 50 adjusts the image data captured by the camera 40 to a size of the display unit 60, and converts the image data captured by the camera 40 on the basis of a color standard of image data to be displayed on the display unit 60.

Referring to FIG. 2A, a camera interface 311 performs an interface function for image data output from the camera 40. It is assumed that the image data output from the camera 40 is based on a YUV format, and the display unit 60 displays image data of an RGB format. In an embodiment of the present invention, it is assumed that the image data output from the camera 40 is based on a YUV422 (16 bits) format and fixed to a common intermediate format (CIF) size of 352×288. Moreover, it is assumed that the display unit 60 based on the RGB format has a size of 128×112.

In response to a control signal output from the controller 10, a scaler 313 scales image data captured by the camera 40 such that the image data can be displayed on the display unit 60. That is, as described above, the number of pixels of the image data captured by the camera 40 is the CIF size of 352×288, and the number of pixels of image data capable of being displayed is 128×112 or 128×96. Thus, the scaler 313 reduces and crops the pixels of the image data output from the camera 40 to the number of the pixels of the image data capable of being displayed on the display unit 60. However, if the display unit 60 can display image data having a size larger than the size of the image data output from the camera 40, the scaler 313 can be designed such that the image data output from the camera 40 can be enlarged and displayed under the control of the controller 10. A method for displaying the enlarged image data selects the number of pixels capable of being displayed from the image data output from the camera 40, and displays the selected pixels.

A color converter 315 converts YUV data output from the scaler 313 into RGB data, and then outputs the RGB data. When the camera 40 generates the image data in the RGB format or the display unit 60 can display image data of the YUV format, the configuration of the color converter 315 can be omitted.

A liquid crystal display (LCD) interface 317 performs an interface function for image data with the display unit 60. The LCD interface 317 includes an internal buffer (not shown), and performs buffering for the image data interfaced with the display unit 60.

The controller 10 controls an image codec 350 to compress the captured image data or recover the compressed image data. In an embodiment of the present invention, the image codec 350 is a joint photographic experts group (JPEG) codec.

A control interface 321 performs an interface function between the image processor 50 and the controller 10, and between the display unit 60 and the controller 10.

In response to a path control signal output from the controller 10, a selector 319 selects data output from the image processor 50 or data output from the controller 10, and outputs the data to the display unit 60. Here, a first path control signal is a signal for activating a bus between the image processor 50 and the display unit 60, and a second path control signal is a signal for activating a path between the controller 10 and the display unit 60. The controller 10 allows the display unit 60 to perform a two-way communication through the selector 319.

Except for the color converter 315 being connected between the camera 40 and the scaler 313, a configuration shown in FIG. 2B is similar to that shown in FIG. 2A and also an operation of the configuration shown in FIG. 2B is similar to that of the configuration shown in FIG. 2A.

An operation of transmitting image data captured by the camera 40 to the display unit 60 will now be described. The image processor 50 controls a transmission rate of moving picture data captured by the camera 40, and stores input image data in a memory of the display unit 60 through the LCD interface 317. Here, a size of image data corresponding to one frame output from the camera 40 is a CIF size of 352×288, and pixels of the image data from the camera are reduced and partially removed (or cropped) on the basis of the number of pixels (128×12 or 128×96) of image data corresponding to one frame capable of being displayed. Thus, the scaler 313 of the image processor 50 partially removes the pixels of the image data output from the camera 40 or selects a partial area of the pixels such that the display unit 60 can appropriately display the image data from the camera 40 on a zoom screen. The transmission rate of the image data is fixedly designated on the basis of a master clock. A flow of image data between the camera 40, the image processor 50 and the display unit 60 is affected by an access rate for the display unit 60. Thus, the LCD interface 317 includes a buffer such that a rate of the image data to be read from the camera 40 and a rate of the image data to be written to the display unit 60 can be adjusted, and which also temporarily buffers the data in the buffer.

In displaying a moving picture screen corresponding to image data captured by the camera 40 on the display unit 60, the user can capture a still picture from the displayed image data and store the captured still picture. That is, the user can store the display image data as the still picture using a still-picture capture key arranged on the key input unit 27. If a still-picture capture command is generated, the controller 10 terminates transmitting an output of the image processor 50 to the display unit 60, and then reproduces an image displayed on the display unit 60 as the still picture and drives an image codec 350. That is, if the still-picture capture command is generated, the controller 10 performs a control operation such that image data input into the scaler 313 or image data output from the scaler 313 can be applied to the image codec 350. The image data input into the scaler 313 has a size of an image captured by the camera 40, and the image data output from the scaler 313 has a size of an image to be displayed on the display unit 60. Thus, the size of the image data input into the scaler 313 is different from that of the image data output from the scaler 313.

The image codec 350 receives the image data of one frame corresponding to the displayed image, and encodes the input image data in the JPEG format to output the encoded image data to the control interface 321. Then, the controller 10 stores compressed image data as a still picture in the memory 30.

Data output from the camera 40 is then captured and registered as the still picture. When the registered still picture is reproduced, the image codec 350 recovers the still picture to original image data, and outputs the recovered image data to the scaler 313. The scaler 313 scales the recovered image data to a size of the display unit 60, and then a control operation can be performed such that the scaled image data is applied to the display unit 60. In an embodiment of the present invention, after the image data output from the scaler 313 is captured and registered as the still picture, the image codec 350 recovers the still picture to original image data when the registered still picture is reproduced, and a control operation can be performed such that the recovered image data can be directly applied to the display unit 60.

In an embodiment of the present invention, it is assumed that the image data registered as the still picture corresponds to a frame next to the displayed image data. That is, items of image data of current and next frames among image data displayed as moving pictures are displayed on the same screen. Thus, the image data items of the current and next frames can be regarded as substantially the same image data. However, the image data of the current frame displayed on the display unit 60 through the LCD interface 317 can be accessed and registered as the still picture.

Before image data captured by the camera 40 is scaled, the image codec 350 compresses the image data in real time while buffering a part of the image data, and the compressed image data can be transmitted under the control of the controller 10. At this time, an operation of the LCD interface 317 associated with a preview state is stopped and a pause state of the display unit 60 is maintained.

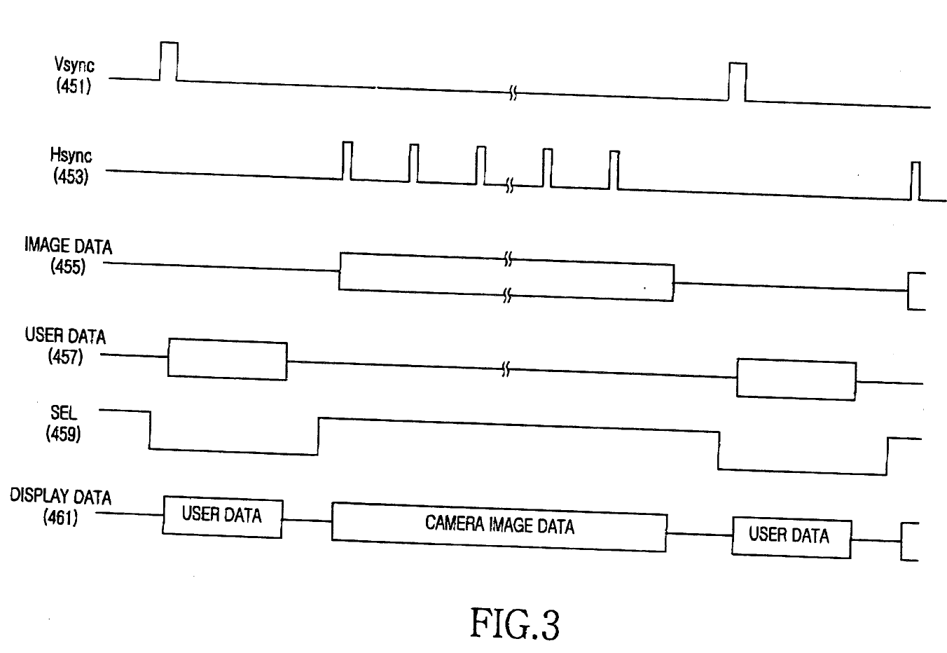

FIG. 3 is a timing diagram illustrating an example of transmission timings of data and signals used for the mobile communication terminal shown in FIG. 1 in accordance with an embodiment of the present invention. Specifically, FIG. 3 is a timing diagram illustrating an example of transmission timings of image data captured by the camera 40 and user data generated by the controller 10 to the display unit 60 in accordance with an embodiment of the present invention. In an embodiment of the present invention, moving picture data captured by the camera 40 and the user data generated by the controller 10 are transmitted in units of frames.

The user data is generated from the user data generator 11 included in the controller 10. The user data includes first user data for indicating menu information of a display image, and second user data for indicating an operating state of the mobile communication terminal. The first user data contains a still-picture menu item for storing a displayed moving picture as a still picture in the image capture mode, a release menu item for releasing the image capture mode, an edition menu item for editing the displayed moving picture, etc. Further, the second user data contains information indicating a remaining amount of battery power of the mobile communication terminal, reception sensitivity, and a current time, etc.

Referring to FIG. 3, in an embodiment of the present invention, a frame period is set using a vertical synchronous signal, and image data captured by the camera 40 is transmitted to the display unit 60 at a frame start time point. User data generated by the controller 10 is transmitted to the display unit 60 in a period of time between a time point when the image data of one frame is completely transmitted and a time point when image data of a next frame is transmitted. The display unit 60 includes a first display area for displaying the image data and a second display area for displaying the user data. The display unit 60 displays moving pictures and the user data while simultaneously updating the image data and the user data in units of frames. Here, the user data includes menu information in an image capture mode, information indicating a remaining amount of battery power of the mobile communication terminal, reception sensitivity, a current time, etc.

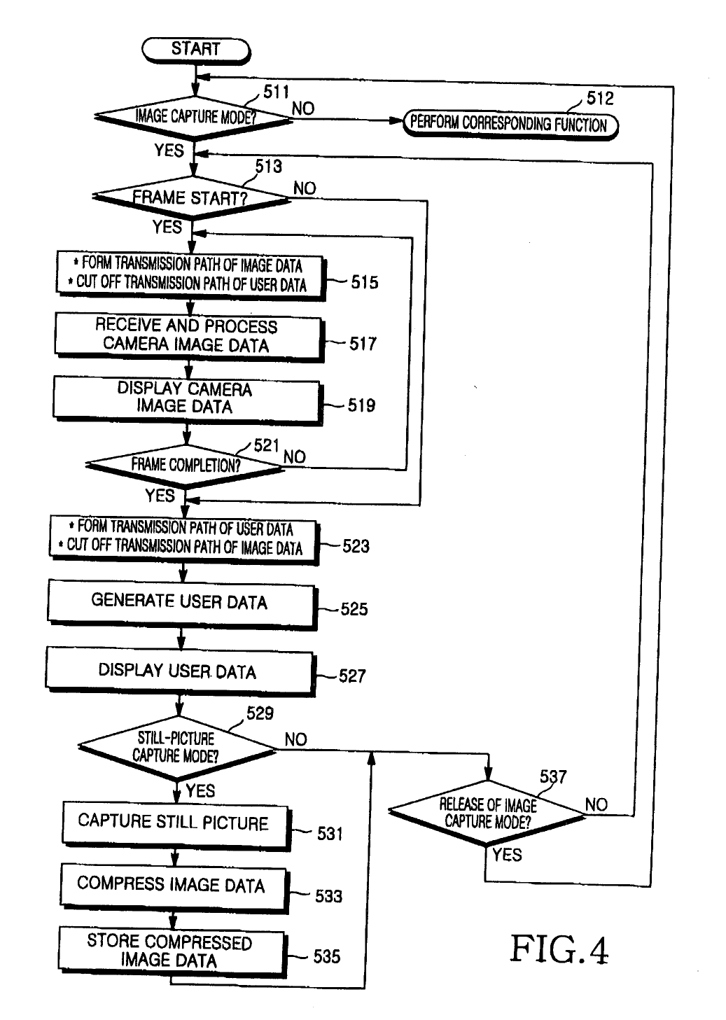

FIG. 4 is a flow chart illustrating an example of steps for displaying image data in the mobile communication terminal in accordance with an embodiment of the present invention. Specifically, FIG. 4 is a flow chart illustrating an example of steps for transmitting image data captured by the camera 40 and image data generated by the controller 10 to the display unit 60 and displaying the image data on the display unit 60, capturing a still picture from an image displayed on the display unit 60 and storing the captured still picture in accordance with an embodiment of the present invention.

Referring to FIGS. 3 and 4, when the captured image must be displayed on the display unit 60, the user generates key data for driving the camera 40 using the key input unit 27. In embodiments of the present invention a key for driving an image capture mode can use a specified key arranged on the key input unit 27 or can be selected in a menu displayed by a menu key input. If the image capture mode is not selected at step 511, the method proceeds to step 512 where other functions are performed by the mobile communication terminal such as performing voice and data communications. If the image capture mode is selected, the controller 10 detects the selected image capture mode at step 511, and drives the camera 40 through an I2C interface 323. Then, the camera 40 is driven and an image capture operation is initiated. At this time, the camera 40 generates captured image data and horizontal and vertical synchronous signals. Further, after the controller 10 drives the camera 40, the controller 10 waits for a signal to be generated at step 513, wherein the signal activates a path capable of receiving the captured image data by controlling the camera 40 and the image processor 50.

As described above, the camera 40 generates the captured image data and the synchronous signals HREF and VREF in the image capture mode. Here, the synchronous signal HREF and the synchronous signal VREF are a horizontal synchronous signal and a vertical synchronous signal, i.e., a frame synchronous signal, respectively. Typically, the horizontal synchronous signal is a synchronous signal for providing image data of one line, and the vertical synchronous signal is generated when image data of one frame (or field) has been completely captured. Thus, the timing relationship between the horizontal and vertical synchronous signals can be indicated by reference numerals 451 and 453 shown in FIG. 3. If a predetermined time elapses after the vertical synchronous signal is generated when the image data of one frame (or field) has been completely captured, image data of a next frame is captured. That is, if the predetermined time elapses after the vertical synchronous signal indicated by the reference numeral 451 is generated, image data of the next frame (or field) is generated. Thus, in an embodiment of the present invention, after the vertical synchronous signal is generated, user data is transmitted to the display unit 60 in the predetermined time. Then, before the image data of the next frame is output, a path for transmitting image data output from the camera 40 to the display unit 60 is selected. That is, an output path of the camera 40 is selected in a first display time for generating image data at a period of one frame, and the user data generated from the controller 10 is selected in a second display time before the image data of the next frame is generated. In an embodiment of the present invention, a frame start time point is set at a time when the horizontal synchronous signal of the next frame is generated a predetermined time after the vertical synchronous signal was generated, and the output path of the camera 40 is formed. When the synchronous signal VREF is terminated, an interrupt signal indicating a frame termination is used.

If the predetermined time elapses after the vertical synchronous signal VREF indicated by the reference numeral 451 shown in FIG. 3 is generated, the controller 10 determines a frame start time point at step 513. Then, at step 515, the controller 10 generates an SEL signal having a high logic level indicated by a reference numeral 459 shown in FIG. 3, and generates a first path control signal for selecting the output of the camera 40. If the first path control signal is generated, the selector 319 selects an output of the LCD interface 317 to transfer the output of the camera 40 to the display unit 60. At this time, a path of the control interface 321 is cut off. At step 517, image data output from the camera 40 is processed in units of lines, and the processed image data is transferred to the display unit 60. At step 519, the image data is displayed as a moving picture on the display unit 60. At this time, the scaler 313 of the display unit 60 scales the image data of a common intermediate format (CIF) size output from the camera 40 on the basis of a display size of the display unit 60. The converter 315 converts the image data based on a YUV format into an RGB format's image data, and outputs the converted image data. The LCD interface 317 buffers the image data received in units of lines, and outputs the image data to the display unit 60 at an appropriate time. An operation of displaying the image data from the camera 40 is repeated in units of lines until the image data of one frame is completely transmitted.

If the synchronous signal VREF is generated, the controller 10 detects the completion of a one-frame display at step 521. At step 523, the SEL signal having a low logic level is generated and a second path for outputting the user data from the controller 10 to the display unit 60 is selected. Then, the selector 319 selects an output of the control interface 321, and cuts off a path of the LCD interface 317. If the second path is selected, the controller 10 generates and outputs the user data to be updated at step 525, and the selector 319 outputs the user data to the display unit 60 at step 527. The user data includes general information indicating a current time, reception sensitivity, a remaining amount of a battery of the mobile communication terminal, etc. and data indicating a menu of various modes selectable by the user in the image capture mode. Thus, the display unit 60 displays the image data of the frame and the updated user data on one screen at a one-frame time interval.

The display unit 60 can be divided into an image display area or a first display area for displaying the image data output from the camera 40 on a preview screen, and an area for displaying the user data. The user data display area can be an area or a second display area arranged at the upper portion and/or lower portion of the image display area. Thus, if the first path is selected, the display unit 60 displays the image data from the camera 40 on the first display area. Otherwise, if the second path is selected, the display unit 60 displays the user data from the controller 10 on the second display area.

If a predetermined time elapses after the user data is output to the display unit 60, the initiation of a next frame is sensed at step 513. Before a horizontal synchronous signal of the next frame is generated, the SEL signal having the high logic level indicated by the reference numeral 459 shown in FIG. 3 is generated. The above-described procedure is repeated, and an operation of displaying image data of a frame subsequent to the next frame and user data is performed.

An operating state as described above refers to a state for displaying a preview screen. The image data captured by the camera 40 is displayed as a moving picture on the first display area, and the user data output from the controller 10 is displayed on the second display area. As described above, when the preview screen is displayed, the user can identify the displayed moving picture, and generate a still-picture capture command for obtaining a still picture at a specified time point. The still-picture capture command can be generated using a specified function key arranged on the key input unit 27. In an embodiment of the invention, the still-picture capture command can be selected using a menu key displayed on the display unit 60. If the still-picture capture command is generated, the controller 10 detects the still-picture capture command at step 529. At step 531, the controller 10 controls the image processor 50 and cuts off an output path of the image data output from the camera 40. Further, the controller 10 performs a control operation such that displayed image data can be applied to the image codec 350 or the image data captured by the camera 40 can be applied to the image codec 350. That is, if the still-picture capture command is generated, the controller 10 performs a control operation such that a still-picture captured from the preview screen can be displayed on the display unit 60. The image data input into the scaler 313 or output from the scaler 313 is applied to the image codec 350. At this time, the image data input into the scaler 313 is the size of an image captured by the camera 40, and the image data output from the scaler 313 is the size of an image screen of the display unit 60. Further, the controller 10 performs a control operation such that the image codec 350 can compress the image data of the captured still-picture at step 533. The controller 10 accesses the compressed image data and then stores the compressed image data as the still picture in the memory 30 at step 535. At this time, the controller 10 performs a control operation such that the display unit 60 can display menu information for storing the captured image data as the still picture. In an embodiment of the invention, if the still-picture command is generated, a control operation is performed such that a still picture is display on the preview screen and the image data captured by the camera 40 is input into the image codec 350. Here, the menu information input by the user can include information for inputting a still-picture name and a name of a place in which the still picture is captured. Moreover, still-picture information input by the user can be registered along with a still-picture capture time. At step 535, the controller 10 can register the still picture, the still-picture name, the name of a place in which the still picture is captured, the still-picture capture time, etc. When the still-picture capture operation is completed, the controller 10 returns to the above step 513, and repeats an operation of displaying a moving picture on the preview screen.

At step 537, the controller 10 determines whether a release of the image capture mode has been received. If the release of the image capture mode has not been requested, the controller 10 returns to step 513 and determines the initiation of a next frame. Otherwise, if the release of the image capture mode has been requested, the controller 10 releases the image capture mode and returns to step 511.

As described above, the controller 10 cuts off a display path through the controller 10 when the image data is generated in the image capture mode on the basis of a unit of a frame. Thus, an output path of the camera 40 is formed and the image data captured by the camera 40 is output to the display unit 60. Meanwhile, the controller 10 cuts off a display path through the camera 40 when the generation of the frame image data is terminated. An output path of the user data generated from the controller 10 is formed, and the user data is output to the display unit 60. The image processor 50 has a right to use a bus when the image data is generated in units of frames. The controller 10 has the exclusive right to use the bus when the image data is not generated. Therefore, the image data from the camera 40 and the user data from the controller 10 are transmitted independently, and data displayed on the display unit 60 can be updated.

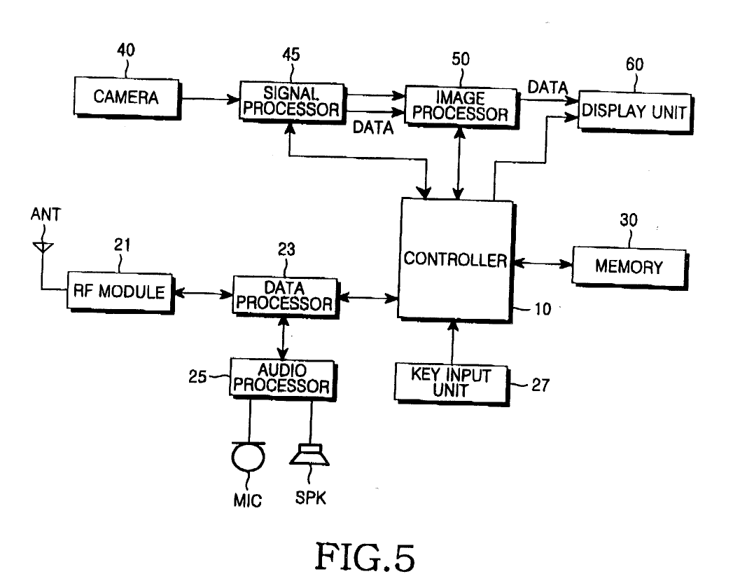

FIG. 5 is a block diagram illustrating another example of components of the mobile communication terminal in accordance with an embodiment of the present invention. The mobile communication terminal shown in FIG. 5 is different from that shown in FIG. 1. In FIG. 1 a signal processor 45 which separates the camera 40 from the image processor 50 is not shown. Referring to FIG. 5, the camera 40 includes a charge coupled device (CCD) image sensor or a complementary metal oxide semiconductor (CMOS) image sensor. The signal processor 45 converts an image signal captured by the camera 40 into digital image data.

The camera 40 for capturing an object's image includes a camera sensor (not shown) for converting an optical signal of the captured object's image into an electric signal. In an embodiment of the present invention, the camera sensor is a CCD image sensor. The signal processor 45 converts the image signal received from the camera 40 into digital image data. In an embodiment of the invention, the signal processor 45 can be implemented by a digital signal processor (DSP). When the signal processor 45 is separate from the camera 40, the size of the camera 40 can be reduced and hence the mobile communication terminal can be equipped with the camera 40 having a reduced size.

Except for the signal processor 45 being separate from the camera 40, other elements shown in FIG. 5 are similar to those shown in FIG. 1. The operations of the elements shown in FIG. 5 are similar to those of the elements shown in FIG. 1. Hence, the elements do not need to be discussed.

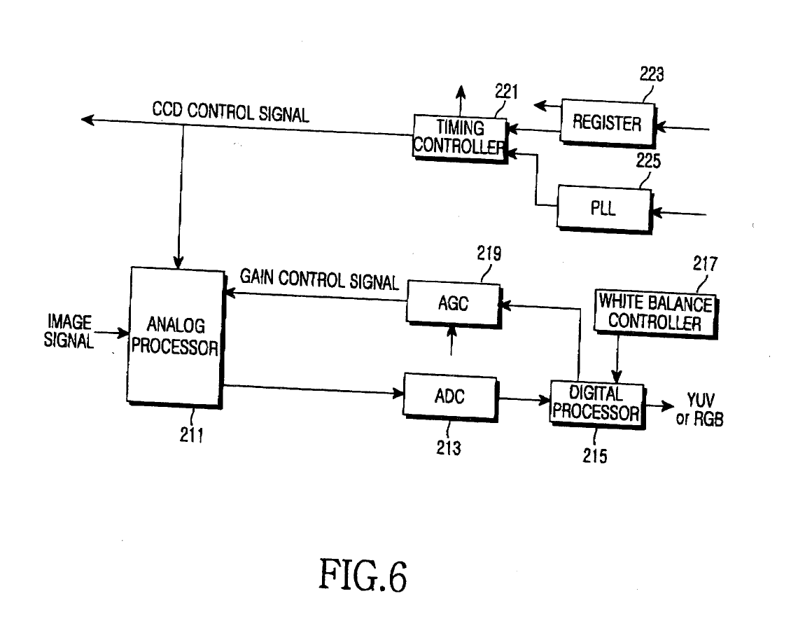

FIG. 6 is a block diagram illustrating an example of components of the signal processor 45 shown in FIG. 5 in accordance with an embodiment of the present invention.

Referring to FIG. 6, an analog processor 211 receives an analog image signal received from the sensor of the camera 40, and controls the amplification of the image signal in response to a gain control signal. An analog-to-digital converter (ADC) 213 converts the analog image signal received from the analog processor 211 into digital image data and then outputs the digital image data. The ADC 213 can be an 8-bit ADC. A digital processor 215 receives an output of the ADC 213, converts the digital image data into YUV or RGB data and outputs the YUV or RGB data. The digital processor 215 includes an internal line memory or frame memory, and outputs the processed image data in units of lines or frames. A white balance controller 217 controls a white balance of light. An automatic gain controller (AGC) 219 generates the gain control signal for controlling a gain of the image signal, and outputs the generated gain control signal to the analog processor 211.

A register 223 stores control data received from the controller 10. A phase-locked loop (PLL) circuit 225 generates a reference clock to control an operation of the signal processor 45. A timing controller 221 receives the reference clock from the PLL circuit 225, and generates a timing control signal to control the operation of the signal processor 45.

An operation of the signal processor 45 will now be described. The camera 40 includes a charge coupled device (CCD) image sensor, and converts an optical signal of the captured image into an electric signal to output the electric signal. The analog processor 211 processes the image signal received from the camera 40. The analog processor 211 controls a gain of the image signal in response to a gain control signal. The ADC 213 converts the analog image signal received from the analog processor 211 into digital image data and then outputs the digital image data. The digital processor 215 includes a memory (not shown) for storing the image data, converts the digital image data into RGB or YUV image data, and outputs the RGB or YUV image data. The memory storing the digital image data can be implemented by a line memory for storing the image data in units of lines or a frame memory for storing the image data in units of frames. It is assumed that the line memory is employed in accordance with an embodiment of the present invention. Moreover, it is assumed that the digital processor 215 converts the digital image data into the YUV image data in accordance with an embodiment of the present invention.

The white balance controller 217 generates a control signal for controlling a white balance of the image signal. The digital processor 215 adjusts a white balance of the processed image data. The AGC 219 generates a signal for controlling a gain of the image signal and applies the gain control signal to the analog processor 211. The register 223 stores a mode control signal received from the controller 10. The PLL circuit 225 generates a reference clock used in the signal processor 45. The timing controller 221 generates various control signals for the signal processor 45 in response to the reference clock received from the PLL circuit 225.

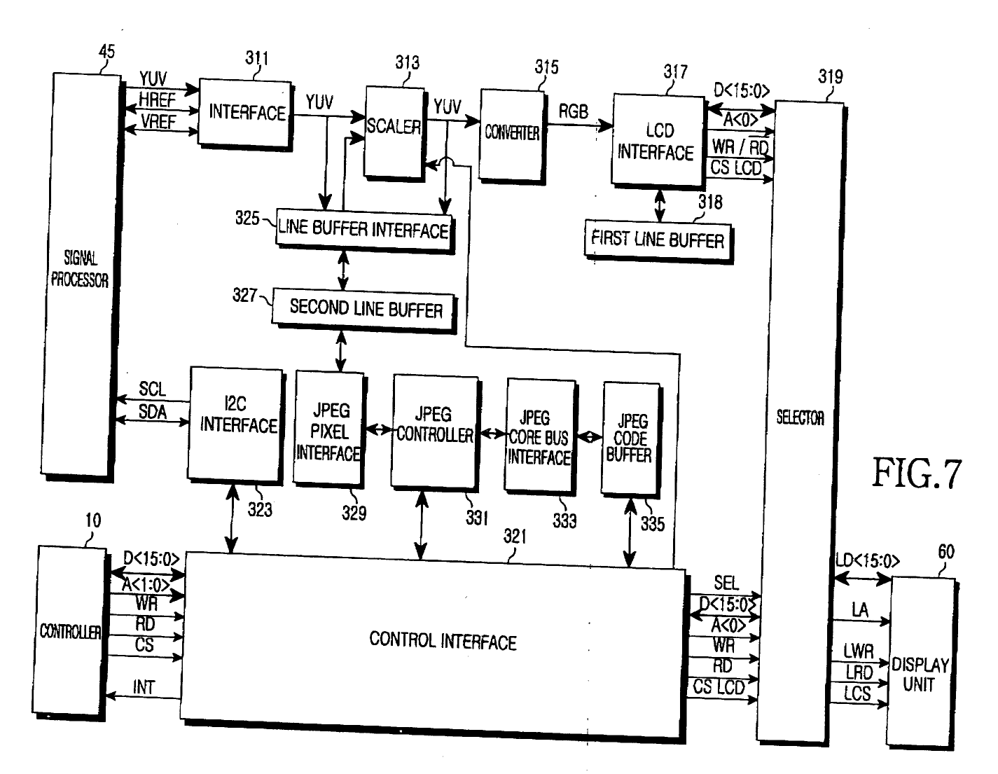

FIG. 7 is a block diagram illustrating an example of components of the image processor 50 shown in FIG. 1 or FIG. 5 in accordance with an embodiment of the present invention.

Referring to FIG. 7, the image processor 50 performs a an interface function for image data between the signal processor 45 and the display unit 60, and compresses and decompresses data of image signals received from the camera 40 in a joint photographic experts group (JPEG) format. The image processor 50 performs a function of generating a thumbnail screen by cropping pixels and lines of the compressed image data.

Referring to FIG. 7, the image processor 50 has the following components.

A digital picture processor is configured by a camera interface (hereinafter, referred to as a CCD interface) 311, a scaler 313, a converter 315, a display interface (hereinafter, referred to as an LCD interface) 317 and a first line buffer 318. The digital picture processor performs an interface function for the image signals between the camera 40 and the display unit 60. Typically, the number of pixels of the image signals of a screen received from the camera 40 is different from the number of pixels of image signals of a screen capable of being displayed on the display unit 60. Accordingly, the digital picture processor performs the interface function for the image signals between the camera 40 and the display unit 60. In an embodiment of the present invention, the digital picture processor scales image data of YUV211 (or YUV422) format-based 16 bits received from the signal processor 45, and reduces and crops the image data to a size of 128×112 or 128×96 by cutting upper, lower, left and right ends of a picture corresponding to the image data. It is assumed that the digital picture processor converts the processed image data into an RGB444 format and then transmits the converted image data to the display unit 60.

The CCD interface 311 of the digital picture processor performs an interface for a YUV422 (16 bits) format picture and synchronous signals HREF and VREF from the signal processor 45. In an embodiment of the present invention, the HREF and VREF signals can be generated from the CCD interface 311 and supplied to the signal processor 45. The HREF is used as a horizontal valid time flag and a line synchronous signal. The HREF is a signal for reading the image data, stored in a line memory, in units of lines. The line memory is located in the digital processor 215 contained in the signal processor 45. The VREF is used as a vertical valid time flag and a frame synchronous signal. The VREF is also used as a signal for enabling the signal processor 45 to output data of the image signals captured by the camera 40. The VREF is generated in a unit of one frame and can be a vertical synchronous signal.

The LCD interface 317 of the digital picture processor can access the image data of the controller 10 and the digital picture processor using a switching function of a selector 319. In FIG. 7, LD<15:0> indicates a data bus. The data bus is directed to an output operation, except when data is read from the display unit 60 or LRD is asserted. LA, LCS, LWR and LRD are an address signal, a selection signal for the display unit 60, a write signal and a read signal, respectively.

A joint photographic experts group (JPEG) processor is configured by a line buffer interface 325, a second line buffer 327, a JPEG pixel interface 329, a JPEG controller 331, a JPEG core bus interface 333 and a JPEG code buffer 335. The JPEG processor can be a JPEG codec. The JPEG processor compresses the image data received from the signal processor 45 into a JPEG format to output code data to the controller 10, or decompresses compressed code data received from the controller 10 in the JPEG format to output the decompressed data to the digital picture processor. In an embodiment of the present invention, the JPEG processor compresses YUV211 (or YUV422) format-based image data (based on a common intermediate format (CIF) size) received from the CCD interface 311 or compresses scaled and cropped image data of a size of 128×112 or 128×96 in the JPEG format, and then outputs code data. Code data received from the controller 10 is decompressed in the JPEG format and then the decompressed data is transmitted to the digital picture processor.

An operation of the JPEG processor will be described.

The line buffer interface 325 applies the YUV422 format-based image data received from the CCD interface 311 to the second line buffer 327. The second line buffer 327 buffers or stores the received image data in units of lines. The JPEG pixel interface 329 transfers, to the JPEG controller 331, the image data stored in the second line buffer 327 in units of lines. If so, the JPEG controller 331 compresses the received image data and then outputs the compressed image data to the bus interface 333. Then, the JPEG controller 331 decompresses the compressed image data received from the bus interface 333 and then outputs the decompressed data to the pixel interface 329. The bus interface 333 performs an interface between the JPEG controller 331 and the JPEG code buffer 335. The JPEG code buffer 335 performs a buffering function for the JPEG image data received from the controller 10 through the JPEG controller 331 and the control interface 321.

The control interface 321 performs an interface function between the image processor 50 and the controller 10, and between the display unit 60 and the controller 10. That is, the control interface 321 serves as a common interface for accessing the register of the image processor 50, the JPEG code buffer 335, and for accessing the display unit 60 through the image processor 50, and for controlling a scaler operation. D<15:0> and A<1:0> indicate a data bus and an address bus, respectively. CS, WR, RD and SEL are a selection signal for the image processor 50 and the display unit 60, a write signal, a read signal and a path control signal for the selector 319, respectively.

In response to a path control signal output from the controller 10, the selector 319 selects data output from the image processor 50 or data output from the controller 10, and outputs the data to the display unit 60. A first path control signal refers to a signal for activating a bus between the image processor 50 and the display unit 60, and a second path control signal refers to a signal for activating a path between the controller 10 and the display unit 60. Moreover, the controller 10 enables the display unit 60 to perform two-way communication through the selector 319.

An I2C interface 323 allows the controller 10 to directly access the signal processor 45. That is, the I2C interface 323 controls the signal processor 45, and the controller 10 can access the signal processor 45 irrespective of the I2C interface 323, as in the case where data is read from a conventional register or written to the conventional register. SDA associated with the I2C interface 323 refers to I2C data for a CCD module, which is exchanged with the signal processor 45. SCL associated with the I2C interface 323 refers to an I2C clock for the CCD module.

An operation of the digital picture processor will now be described with reference to FIG. 7. The CCD interface 311 performs interface function for the image data output by the signal processor 45. The image data is based on YUV422 (16 bits) and fixed to a CIF size of 352×288. In accordance with an embodiment of the present invention, the scaler 313 scales data of the image signals captured by the camera 40 in response to a control signal received from the controller 10, such that the scaled image data is displayed on the display unit 60. That is, the number of pixels of the image signals received from the camera 40 corresponds to the CIF size of 352×288, and the number of pixels of image signals capable of being displayed on the display unit 60 corresponds to a size of 128×112 or 128×96. Thus, the scaler 313 reduces and crops the pixels of the image signals received from the camera 40 to create the number of the image signal pixels capable of being displayed on the display unit 60. Moreover, the scaler 313 can enlarge the pixels of the image signals received from the camera 40 such that the enlarged pixels can be displayed. In a method for enlarging and displaying the pixels, the pixels of the image signals received from the camera 40 are selected by the number of pixels capable of being displayed on the display unit 60 and the selected image signal pixels can be displayed. The color converter 315 converts YUV data received from the scaler 313 into RGB data and then outputs the RGB data. The LCD interface 317 performs an interface function for the image data of the display unit 60. The first line buffer 318 performs buffers the image data interfaced between the LCD interface 317 and the display unit 60.

An operation of capturing image signals through the camera 40 and displaying the captured image signals on the display unit 60 will now be described.

First, an operation of transmitting the image signals captured by the camera 40 to the display unit 60 will be described.

The image processor 50 controls a transmission rate of image data received from the signal processor 45, and stores the received image data in the memory of the display unit 60 through the LCD interface 317. A size of image signals received from the CCD image sensor is a CIF size of 352×288. Pixels of the image signals are reduced and partially removed (or cropped) such that the number of pixels capable of being displayed on the display unit 60 is created. The scaler 313 of the image processor 50 removes some pixels or selects pixels of a specified area such that the pixels received from the signal processor 45 can be displayed on the display unit 60. A flow of image data through the signal processor 45, the image processor 50 and the display unit 60 is affected by an access rate for the display unit 60. Thus, the LCD interface 317 supports a function of temporarily buffering the data in the first line buffer 318 such that a rate of the image data to be read from the signal processor 45 and a rate of the image data to be written to the display unit 60 can be adjusted.

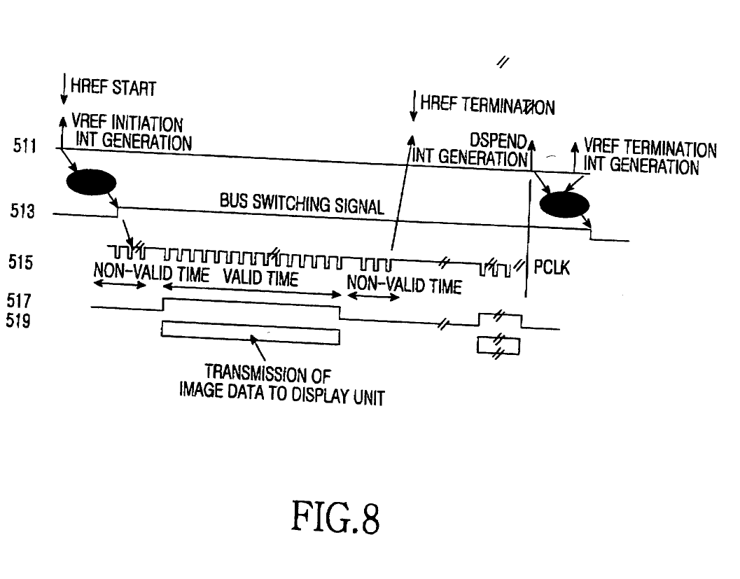

FIG. 8 is a timing diagram illustrating an example of timing signals for transmitting an image signal captured by a camera from an image processing device shown in FIG. 5 to a display unit in accordance with an embodiment of the present invention. Specifically, FIG. 8 is a timing diagram illustrating an example of timing signals for processing the image data received from the image processor 50 in response to synchronous signals VREF and HREF from the CCD image sensor.

As indicated by a reference numeral 511 shown in FIG. 8, the controller 10 detects an interrupt signal at a rising edge of the VREF signal. When sensing the VREF signal, the controller 10 activates a bus switching signal as indicated by a reference numeral 513 shown in FIG. 8, and gives a bus use right to a CCD path of the image processor 50. That is, the controller 10 generates an SEL signal having a high logic level and a first path control signal. Then, the controller 10 controls the selector 319 such that an output of the LCD interface 317 can be applied to the display unit 60. As described above, if the bus use right is given to the CCD path of the image processor 50, the image processor 50 generates a clock signal PCLK as indicated by a reference numeral 515 shown in FIG. 8 and a horizontal valid section signal as indicated by a reference numeral 517 shown in FIG. 8. The horizontal valid section signal can be a horizontal synchronous signal HREF. Thus, as indicated by the reference numerals 515 and 517, the image processor 50 transmits the image data in units of lines. That is, the scaler 313 scales the CIF image data to a size of a display screen of the display unit 60, and the converter 315 converts the image data based on the YUV422 format into the image data based on the RGB444 format to apply the RGB444 format-based image data to the LCD interface 317. The line image data is transmitted during a valid time period as indicated by a reference numeral 519 shown in FIG. 8. The selector 319 then selects an output of the LCD interface 317, and the image data is transmitted to the display unit 60. The display unit 60 stores the image data in an internal memory. If the image processor 50 completes the transmission of the predetermined number of pixels, the signal processor 45 generates a DSPEND signal. The controller 10 generates a VREF termination signal at a time when the image data of one frame is completely transmitted. The image processor 50 detects a VREF termination time, generates an interrupt signal indicating a VREF termination, and transmits the interrupt signal shown in FIG. 8 to the controller 10.

The controller 10 detects the fact that the image data of the one frame has been completely transmitted, through the VREF termination signal. The controller 10 changes the SEL signal to a signal of the low logic level, generates the second path control signal, and outputs a WR signal and user data. If so, the selector 319 transmits the user data output from the control interface 312 to the display unit 60. The display unit 60 displays the user data on a user data display area arranged at the upper portion and/or lower portion of an image data display area. The user data includes time information, menu data for setting image data display modes (containing a still-picture capture mode), etc.

If the VREF signal is re-generated, the controller 10 gives the bus use right to the image processor 50 such that the display unit 60 can display the image signals captured by the camera 40 on the image data display area. If the above-described operation is repeated, the controller 10 performs a control operation such that the image processor 50 and the controller 10 can exclusively occupy the bus, and the image signals captured by the camera 40 and user data can be displayed on the image data display area and the user data display area, respectively.

FIG. 8 shows a state that the DSPEND signal is first generated. However, the interrupt signal indicates the VREF termination can be generated first. If any signal is generated, the controller 10 detects the generated signal and the bus use right is given to the controller 10. When the bus is coupled to the CCD path, the controller 10 cannot access the display unit 60. That is, while the data is transmitted through the CCD path, the controller 10 cannot access the display unit 60.

When image data is transmitted through the CCD path, the display unit 60 cannot be accessed. As described above, the controller 10 and the image processor 50 exclusively have a bus access for the display unit 60, respectively. Thus, a time for transmitting the image data in the CCD path is calculated, and the controller 10 must calculate an access time for accessing the display unit 60. The transmission time of the image data is determined by the frequency of a clock PCLK (a master clock) and a frame rate in the signal processor 45.

The scaler 313 of the digital picture processor performs scaling for the number of pixels of image signals captured by the camera 40 to the number of pixels of image signals capable of being displayed on the display unit 60. That is, the number of the pixels of the image signals corresponding to one frame captured by the camera 40 is different from the number of the pixels of the image signals corresponding to one frame capable of being displayed on the display unit 60. The situation where the number of pixels of the image signals corresponding to one frame captured by the camera 40 is larger than the number of the pixels of the image signals corresponding to a frame capable of being displayed on the display unit 60 will now be described. The number of pixels corresponding to a frame captured by the camera 40 is reduced to the number of pixels corresponding to a frame capable of being displayed on the display unit 60. A method for appropriately setting the number of pixels of one frame and displaying the set number of pixels on the display unit 60 can be used. When the number of the pixels is reduced, resolution can be degraded. On the other hand, when the number of pixels is appropriately set, pixels of a specified area can be selected from the captured image and hence an image of the selected pixels can be enlarged or zoomed out while keeping an appropriate resolution.

Otherwise, the number of pixels corresponding to a frame capable of being displayed on the display unit 60 can be larger than the number of pixels corresponding to a frame captured by the camera 40. An interpolating method for inserting pixels between pixels of the image signals captured by the camera 40 can be used. Pixels having an interpolated intermediate value can be inserted between the pixels of the image signals captured by the camera 40. Further, the pixels having the interpolated intermediate value can be inserted between lines.

A method for reducing an original image will now be described.

In an embodiment of the present invention, when the image data is transmitted from the signal processor 45 to the display unit 60, the image data is horizontally and vertically reduced such that 352×288 pixels corresponding to an CIF image received from the signal processor 45 can be inserted into a display area corresponding to 132×132 pixels.

The following Table 1 shows zoom-ratio setting commands for controlling the scaler 313. As shown in the following Table 1, a vertical/horizontal zoom-ratio setting command requires a parameter of one word. The scaler 313 must include a straight-line interpolation filter in a horizontal direction and a device for extracting and processing pixels in a vertical direction. In an embodiment of the present invention, picture processing can be horizontally and vertically adjustable in 256 steps of 1/256˜256/256.

TABLE 1
SCALE parameter (R/W)

| A<1:0> | D<15:8> | D<7:0> | Default |
|---|---|---|---|
| 3h | H_SCALE | V_SCALE | 6464h |
| | <7:0> | <7:0> | |

In Table 1, H_SCALE is a scale ratio setting parameter in a horizontal direction, and a scale ratio=(H_SCALE+1)/256. V_SCALE is a scale ratio setting parameter in a vertical direction and a scale ratio=(V_SCALE+1)/256. For example, where H_SCALE=V_SCALE=150, (150+1)/256=0.5898. In this case, reduction processing of “×0.5898” for an original image (CIF: 352×288) is carried out.

An operation for selecting pixels corresponding to a display area of the display unit 60 and performing a zoom function will now be described. In this case, horizontal and vertical valid sections must be set.

The following Table 2 shows a command (HRANG) for setting a horizontal display initiation position/valid display section. The command requires a parameter of one word. After a scaling operation is performed in response to the command parameter as shown in the following Table 2, a corresponding picture is horizontally cropped to be appropriate to a display size of the display unit 60.

TABLE 2
HRANG parameter (R/W)

| A<1:0> | D<15:8> | D<7:0> | Default |
|---|---|---|---|
| 3h | H_ST <7:0> | H_VAL <7:0> | 240h |

In Table 2, H_ST is a parameter for setting a display initiation position in the horizontal direction, and H_VAL is a parameter for setting a valid display section in the horizontal direction. Actual values of H_ST and H_VAL are a set value ×2, respectively.

The following Table 3 shows a command (VRANG) for setting a vertical display initiation position/valid display section. The command requires a parameter of one word. After a scaling operation is performed in response to the command parameter, a corresponding picture is vertically cropped to be appropriate to a display size of the display unit 60.

TABLE 3
VRANG parameter (R/W)

| A<1:0> | D<15:8> | D<7:0> | Default |
|---|---|---|---|
| 3h | V_ST <7:0> | V_VAL | 0038h |
| | | <7:0> | |

In Table 3, V_ST is a parameter for setting a display initiation position in the vertical direction, and V_VAL is a parameter for setting a valid display section in the vertical direction. Actual values of V_ST and V_VAL are a set value ×2, respectively.

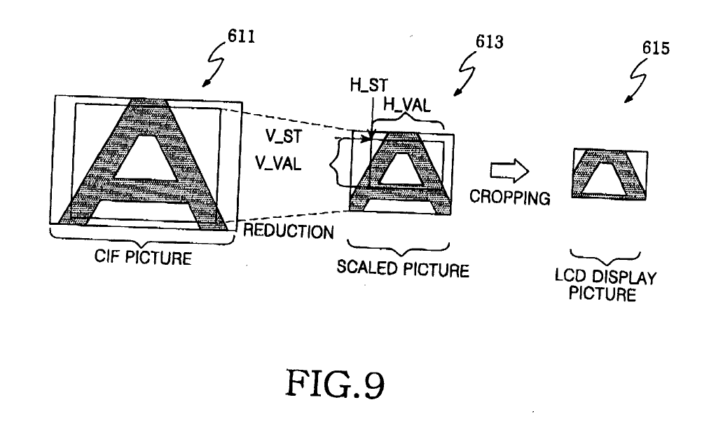

Thus, when the signal processor 45 outputs image data as indicated by a reference numeral 611 shown in FIG. 9, a scaled picture indicated by a reference numeral 613 shown in FIG. 9 is generated and a display picture indicated by a reference numeral 615 shown in FIG. 9 is generated by cropping the scaled picture, if the horizontal valid section associated with the above Table 2 and the vertical valid section associated with the Table 3 are set.

When the number of pixels of image signals corresponding to one screen captured by the camera 40 is different from the number of pixels of image signals corresponding to one screen capable of being displayed, the controller 10 generates a first scale control signal for reducing the pixels of the image signals captured by the camera 40 in response to the user's selection and displaying the reduced pixels on the entire screen of the display unit 60, and a second scale control signal for selecting a predetermined pixel area of the image signals captured by the camera 40 and displaying the selected pixel area on a zoom screen. In response to the first or second scale control signal, the scaler 313 reduces the pixels of the image signals captured by the camera 40 or selects a predetermined pixel area of the image signals captured by the camera 40 (containing pixels capable of being displayed on the display unit 60), such that the scaler 313 outputs the reduced pixels or the selected pixels.

As described, the mobile communication terminal with the camera separately transmits image signals captured by the camera and user data to the display unit 60, thereby preventing collision between display data items. In an embodiment of the present invention, the image processor 50 occupies a right to use a bus in the time when the image data is generated in units of frames. The controller 10 exclusively occupies the right to use the bus at time when the image data is not generated. Therefore, in the mobile communication terminal with the camera 40 in accordance with the present invention, the image data from the camera 40 and the user data from the controller 10 are transmitted independently, and data displayed on the display unit 60 can be updated.

Although the embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims, which follow, along with their full scope of equivalents.

What is claimed is:

1. A device for displaying an image in a mobile communication terminal, comprising:
a camera for capturing an object's image and generating image data;
an image processor for processing the image data generated by the camera on the basis of a predetermined display standard;
a user data generator for generating user data according to a display mode;
a display unit for displaying the image data on a first display area and displaying the user data on a second display area; and
a controller for controlling transmission paths such that the image data from the image processor is transmitted to the first display area of the display unit in a first display time for a frame, and the user data is transmitted to the second display area of the display unit in a second display time, at each frame when an operating mode is an image capture mode.

2. The device as set forth in claim 1, wherein the camera generates the image data of the frame in the first display time, and does not generate the image data of the frame in the second display time.

3. The device as set forth in claim 2, wherein the first display time is a period of time between a time point of generating a first horizontal synchronous signal of the frame and a time point of generating a vertical synchronous signal,
wherein the second display time is a period of time between the time point of generating the vertical synchronous signal and a time point of generating another horizontal synchronous signal.

4. The device as set forth in claim 1, wherein the image processor comprises:
a scaler for scaling the image data outputted from the camera to a display size of the display unit.

5. The device as set forth in claim 4, wherein the image processor further comprises:
a color converter connected to an output terminal of the scaler for performing a color format conversion where the camera outputs image data based on a YUV format and the display unit displays image data based on an RGB format.

6. The device as set forth in claim 4, wherein the image processor further comprises:
a color converter connected to an input terminal of the scaler for performing a color format conversion where the camera outputs image data based on a YUV format and the display unit displays image data based on an RGB format.

7. The device as set forth in claim 1, wherein the user data generator generates first user data for indicating a release of the image capture mode and second user data for indicating a remaining amount of a battery power of the mobile communication terminal, reception sensitivity, time information in the image capture mode.

8. The device as set forth in claim 7, wherein the display unit comprises:
the first display area for displaying the image data; and
the second display area for displaying the second user data at an upper portion of the first display area, and displaying the first user data at a lower portion of the first display area.

9. A device for displaying an image in a mobile communication terminal, comprising:
a camera for capturing an object's image and generating image data;
an image processor including a display data processor for processing the image data generated by the camera on the basis of a predetermined display standard, and an image codec for compressing and decompressing the image data;
a user data generator for generating user data according to a display mode;
a display unit for displaying the image data on a first display area and displaying the user data on a second display area; and
a controller for cutting off a path of the image data by controlling the display data processor in a still-picture capture mode, compressing the image data displayed on the first display area by driving the image codec, and storing the compressed image data as a still picture in a memory.

10. The device as set forth in claim 9, wherein the controller controls transmission paths such that the image data from the image processor is transmitted to the first display area of the display unit in a first display time, and the user data is transmitted to the second display area of the display unit in a second display time, at each frame when an operating mode is an image capture mode.

11. The device as set forth in claim 10, wherein the first display time is a period of time between a time point of generating a first horizontal synchronous signal when valid frame data begins to be transmitted and a time point of generating a vertical synchronous signal, and
wherein the second display time is a period of time between the time point of generating the vertical synchronous signal and a time point of generating another horizontal synchronous signal.

12. The device as set forth in claim 9, wherein the display data processor comprises:
a scaler for scaling the image data outputted from the camera to a display size of the display unit.

13. The device as set forth in claim 12, wherein the image processor further comprises:
a color converter connected to an output terminal of the scaler for performing a color format conversion where the camera outputs image data based on a YUV format and the display unit displays image data based on an RGB format.

14. The device as set forth in claim 12, wherein the image processor further comprises:
a color converter connected to an input terminal of the scaler for performing a color format conversion where the camera outputs image data based on a YUV format and the display unit displays image data based on an RGB format.

15. The device as set forth in claim 9, wherein the user data generator generates first user data for indicating a release of the image capture mode, and second user data for indicating a remaining amount of a battery power of the mobile communication terminal, reception sensitivity, time information in the image capture mode.

16. The device as set forth in claim 15, wherein the display unit comprises:
the first display area for displaying the image data; and
the second display area for displaying the second user data at an upper portion of the first display area, and displaying the first user data at a lower portion of the first display area.

17. A method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of:
activating a transmission path of the image data generated by the camera in a first display time for a frame, processing the image data generated by the camera on the basis of a predetermined display standard, and transmitting the processed image data to the first display area of the display unit; and
inactivating the transmission path of the image data generated by the camera in a second display time, activating a transmission path of the user data, and transmitting the user data to the second display area of the display unit.

18. The method as set forth in claim 17, wherein the first display time is a period of time between a time point of generating a first horizontal synchronous signal when valid frame data begins to be transmitted and a time point of generating a vertical synchronous signal,
wherein the second display time is a period of time between the time point of generating the vertical synchronous signal and a time point of generating another horizontal synchronous signal.

19. A method for displaying an image in a mobile communication terminal, the mobile communication terminal including a camera for capturing an object's image and generating image data, a user data generator for generating user data according to a display mode, and a display unit for displaying the image data on a first display area and displaying the user data on a second display area, the method comprising the steps of:
transmitting the image data generated by the camera and the user data generated by the user data generator to the first and second display areas of the display unit in an image capture mode, and displaying a moving picture;
when a still-picture capture command is generated in the image capture mode, inactivating the transmission path of the image data generated by the camera, displaying the image data displayed on the display unit as a still picture, compressing and encoding the image data displayed on the display unit, and registering the compressed and encoded image data as the still picture.

20. The method as set forth in claim 19, wherein the step of registering the still picture further comprises the step of:
when the still-picture capture command is generated, displaying the user data for registering a still-picture name, a name of a place in which the still picture is captured on the second display area, and registering a user's input information along with the still picture.

21. The method as set forth in claim 20, wherein the step of transmitting the image data and the user data to the display unit comprises the steps of:
activating a transmission path of the image data generated by the camera in a first display time for a frame, processing the image data generated by the camera on the basis of a predetermined display standard, and transmitting the processed image data to the first display area of the display unit; and
inactivating the transmission path of the image data generated by the camera in a second display time, activating a transmission path of the user data, and transmitting the user data to the second display area of the display unit.

22. The method as set forth in claim 21, wherein the first display time is a period of time between a time point of generating a first horizontal synchronous signal when valid frame data begins to be transmitted and a time point of generating a vertical synchronous signal,
wherein the second display time is a period of time between the time point of generating the vertical synchronous signal and a time point of generating another horizontal synchronous signal.
